(19) United States
(12) Patent Application Publication
(10) Pub. No.: US 2026/0132318 A1
(43) Pub. Date: May 14, 2026

(54) STABILIZING COPOLYMER, ADHESIVE COMPOSITION, METHOD OF MAKING THE SAME, AND ARTICLE INCLUDING THE SAME

(71) Applicant: 3M INNOVATIVE PROPERTIES COMPANY, St. Paul, MN (US)

(72) Inventors: Chetan P. Jariwala, Woodbury, MN (US); Brian T. Reski, Woodbury, MN (US); Aaron P. Lindsay, St. Paul, MN (US); Jenny B. Werness, St. Paul, MN (US); Luke T. Dressel, Somerset, WI (US); Joseph A. Orrock, Woodbury, MN (US); Stijn D'Hollander, Kemzeke (BE); Kerstin Unverhau, Neuss (DE); David W. Stegink, Mendota Heights, MN (US)

(21) Appl. No.: 19/119,002

(22) PCT Filed: Oct. 3, 2023
(86) PCT No.: PCT/IB2023/059936

§ 371 Date: Apr. 7, 2025

Related U.S. Application Data
(60) Provisional application No. 63/415,890, filed on Oct. 13, 2022.

(51) Int. Cl. C09J 11/08; C08F 290/06; C09J 4/06; C09J 7/38

(52) U.S. Cl. CPC C09J 11/08; C08F 290/068; C09J 4/06; C09J 7/385; C09J 2301/302; C09J 2301/408; C09J 2301/414; C09J 2400/24

(57) ABSTRACT

An adhesive composition comprises an acrylic copolymer having pendant organosiloxane groups, pendant polyether groups, and optionally acidic groups. An article comprises a substrate having the adhesive composition adhered thereto. A method of making the adhesive composition is also disclosed. Certain acrylic copolymers are disclosed.

### BACKGROUND

Surfactants are widely used in industry. Foam-based articles such as, for example, foam tapes are widely used in home and commercial applications. During manufacture various additives can be used to stabilize polymerizable foams prior to their polymerization.

### SUMMARY

Advantageously, stabilizing copolymers according to the present disclosure can be used as surfactants for stabilizing foams in adhesive compositions, and may be equivalent or superior to other surfactants known for use in applications.

In one aspect, the present disclosure provides an adhesive composition comprising a polymerized composition comprising components:
i) at least one stabilizing copolymer comprising:
   a) 20 to 90 weight percent of at least one first divalent monomer unit represented by:

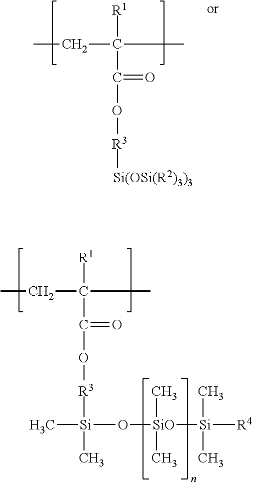

wherein:
   each R¹ is independently H or methyl;
   each R² is independently methyl or ethyl;
   each R³ is independently methylene, ethylene, or propylene;
   each R⁴ is independently methyl, ethyl, propyl, or butyl;
   each n is independently an integer from 2 to 65; and
b) 10 to 80 weight percent of at least one second divalent monomer unit represented by

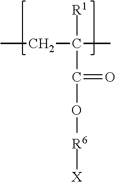

wherein:
   each R⁶ independently represents a poly(alkyleneoxy) group, wherein the poly(alkyleneoxy) group comprises ethyleneoxy groups; and
   each X independently represents H or alkyl having 1 to 6 carbon atoms; and
   at least one first crosslinking agent;
ii) at least one alkyl (meth)acrylate having 7 to 24 carbon atoms;
iii) at least one optional polar free-radically polymerizable monomer; and
iv) at least one second crosslinking agent.

In another aspect, the present disclosure provides an article comprising:
a substrate; and
an adhesive composition according to the present disclosure adhered to the substrate.

In yet another aspect, the present disclosure provides a method of making an adhesive composition, the method comprising the sequential steps:
I) providing a first polymerizable composition comprising:
   at least one alkyl (meth)acrylate;
   at least one optional first polar free-radically polymerizable monomer; and
   at least one first free-radical polymerization initiator;
II) forming a syrup composition by partially polymerizing the first polymerizable composition, wherein the syrup composition comprises:
   1 to 20 weight percent of a solute polymer based on the total weight of the syrup composition, the solute polymer having a weight average molecular weight of at least 100000 daltons; and
   80 to 99 weight percent of solvent monomers based on the total weight of the syrup composition, the solvent monomers comprising:
      the at least one alkyl (meth)acrylate; and
      the at least one optional first polar free-radically polymerizable monomer; and
III) preparing a second polymerizable composition comprising:
   the syrup composition;
   at least one optional second polar free-radically polymerizable monomer, wherein the at least one optional second polar free-radically polymerizable monomer and the at least one optional first polar free-radically polymerizable monomer may be the same or different;
   at least one stabilizing copolymer comprising:
      a) 20 to 90 weight percent of at least one first divalent monomer unit represented by:

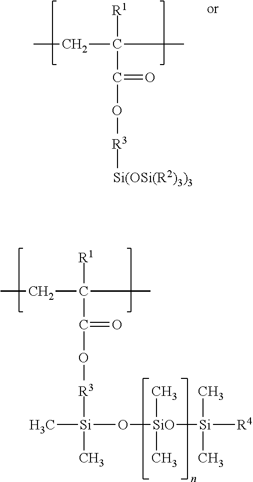

wherein:
each R¹ is independently H or methyl;
each R² is independently methyl or ethyl;
each R³ is independently methylene, ethylene, or propylene;
each R⁴ is independently methyl, ethyl, propyl, or butyl;
each n is independently an integer from 2 to 65; and
b) 10 to 80 weight percent of at least one second divalent monomer unit represented by

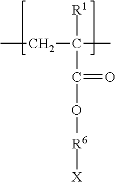

wherein:
each R⁶ independently represents a poly(alkyleneoxy) group, wherein the poly(alkyleneoxy) group comprises ethyleneoxy groups; and
each X independently represents H or alkyl having 1 to 6 carbon atoms;
at least one crosslinking agent;
at least one second free-radical initiator;
IV) frothing the second polymerizable composition to provide a frothed polymerizable composition; and
V) polymerizing the frothed polymerizable composition to form the adhesive composition.

In yet another aspect, the present disclosure provides a stabilizing copolymer comprising:
a) 20 to 90 weight percent of at least one first divalent monomer unit represented by:

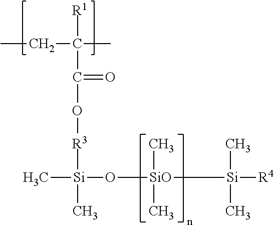

wherein:
   each R¹ is independently H or methyl;
   each R³ is independently methylene, ethylene, or propylene;
   each R⁴ is independently methyl, ethyl, propyl, or butyl;
   each n is independently an integer from 2 to 65; and
b) 10 to 80 weight percent of at least one second divalent monomer unit represented by

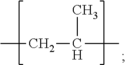

wherein:
   each R⁶ independently represents a poly(alkyleneoxy) group, wherein the poly(alkyleneoxy) group comprises ethyleneoxy groups; and
each X independently represents H or alkyl having 1 to 6 carbon atoms.

All numerical ranges in the specification and claims are inclusive of their endpoints, unless specified otherwise.

As used herein:
the terms “acryloxy” and “acryloyloxy” are equivalent;
the term “ethyleneoxy” refers to the divalent group —CH₂CH₂O—;
the term “isopropyleneoxy” refers to the divalent group

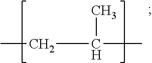

and
the term “(meth)acryl” refers to “acryl” and/or “methacryl”.

Features and advantages of the present disclosure will be further understood upon consideration of the detailed description as well as the appended claims.

### BRIEF DESCRIPTION OF THE DRAWINGS

FIG. 1 is a schematic side view of an exemplary article 100 according to the present disclosure.

It should be understood that numerous other modifications and embodiments can be devised by those skilled in the art, which fall within the scope and spirit of the principles of the disclosure. The FIGURE may not be drawn to scale.

### DETAILED DESCRIPTION

### Stabilizing Copolymer

Useful stabilizing copolymers for stabilizing frothed acrylic foam adhesive precursors may include 20 to 90 weight percent, based on the total weight of the stabilizing copolymer, of at least one first divalent monomer unit a) represented by:

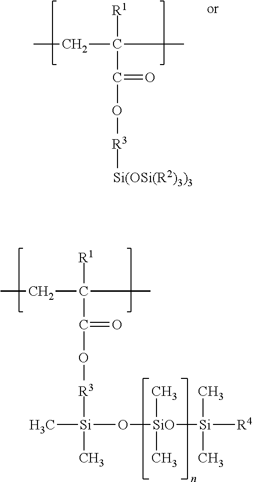

and 10 to 80 weight percent, based on the total weight of the stabilizing copolymer, of at least one second divalent monomer unit b) represented by

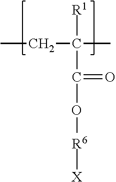

generally corresponding to respective acrylic monomers used in the synthesis of the stabilizing copolymer (e.g., by free-radical copolymerization using a technique known in the art).

Each R¹ is independently H or methyl.

Each R² is independently methyl or ethyl.

Each R³ is independently methylene (i.e., —CH₂—), ethylene (i.e., —CH₂CH₂—), or propylene (i.e., —CH₂CH₂CH₂—).

Each R⁴ is independently methyl, ethyl, propyl, or butyl. In some preferred embodiments, R⁴ is methyl or propyl.

Each n is independently an integer from 2 to 65. In some embodiments, n is independently an integer from 10 to 65. In some embodiments, n is independently an integer from 20 to 65. In some embodiments, n is independently an integer from 30 to 65. In some embodiments, n is independently an integer from 40 to 65. In some embodiments, n is independently an integer from 2 to 50. In some embodiments, n is independently an integer from 5 to 50. In some embodiments, n is independently an integer from 10 to 50. In some embodiments, n is independently an integer from 20 to 50. In some embodiments, n is independently an integer from 15 to 45. In some embodiments, n is independently an integer from 25 to 45. In typical embodiments, monomer units having varying values of n may be present, however this is not a requirement.

Each R⁶ independently represents a poly(alkyleneoxy) group, wherein the poly(alkyleneoxy) group comprises ethyleneoxy groups and optionally other alkyleneoxy groups. In many embodiments, the poly(alkyleneoxy) group is selected from poly(ethyleneoxy), poly(isopropyleneoxy), poly(propyleneoxy), and poly(butyleneoxy). In some embodiments, the poly(alkyleneoxy) group consists of ethyleneoxy groups. In some embodiments, the poly(alkyleneoxy) group consists of ethyleneoxy groups and isopropyleneoxy groups. In some, R⁶ comprises a triblock segment of -poly(isopropyleneoxy)-poly(ethyleneoxy)-poly(isopropyleneoxy)-.

In many embodiments, R⁶ can be represented by the formula:

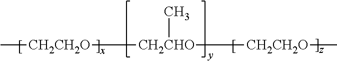

wherein x is an integer greater than or equal to 3, and y and z are integers greater than or equal to 0. In many embodiments, x, y, and z are independently greater than or equal to 6, 8, 10, 12, or 15. In many embodiments, x, y, and z are independently greater than or equal to 25, 20, or 15.

Each X independently represents H or alkyl having 1 to 6 carbon atoms (e.g., methyl, ethyl, propyl, butyl, pentyl, or hexyl).

Monomers suitable for generating monomer unit a) through polymerization can be synthesized, for example, by known methods and/or obtained from commercial sources. Examples of commercially available monomers suitable for generating monomer unit a) include 3-[tris(trimethylsiloxy)silyl]propyl methacrylate (available from Sigma-Aldrich, St. Louis, Missouri); 3-[tris(trimethylsiloxy)silyl]propyl acrylate (available from Career Henan Chemical Company, Zhengzhou, China); mono-methacryloxypropyl-terminated polydimethylsiloxane MCR-M17 (1000 g/mol, available from Gelest, Inc., Morrisville, Pennsylvania); poly(dimethylsiloxane), monomethacrylate-terminated, (available as Cat. No. 798274 from Sigma-Aldrich); X-22-2404 medium chain length, single-end methacrylic-based modified silicone resin (400 g/mol side chain, available from Shin-Etsu Chemical Co., Tokyo, Japan); X-22-174ASX medium chain length, single-end methacrylic-based modified silicone resin (900 g/mol side chain, available from Shin-Etsu Chemical Co.); X-22-174BX medium chain length, single-end methacrylic-based modified silicone resin (2300 g/mol side chain, available from Shin-Etsu Silicones of America, Akron, Ohio); and KF-2012 medium chain length, single-end methacrylic-based modified silicone resin, 4600 g/mol side chain from Shin-Etsu Chemical Co.).

The amount of monomer unit a) may be, for example, 20 to 90 weight percent, 30 to 85 weight percent, 30 to 65 weight percent, or 55 to 65 weight percent, based on the total weight of the stabilizing copolymer. In some embodiments, the amount of monomer unit a) may be, for example, 20 to 45 weight percent or 20 to 30 weight percent, based on the total weight of the stabilizing copolymer.

Monomers suitable for generating monomer unit b) can be prepared, for example, by known methods such as by condensation of (meth)acryloyl chloride or an equivalent and a polyether mono-alcohol or a poly(propylene oxide-co-ethylene oxide) mono-alcohol, or obtained from commercial sources. Examples of commercially available monomers suitable for generating monomer unit b) include SR550 Methoxy Polyethylene Glycol (350) Monomethacrylate, SR551 Methoxy Polyethylene Glycol (350) Monoacrylate, SR552 Methoxy Polyethylene Glycol (550) Monomethacrylate, SR553 Methoxy Polyethylene Glycol (550) Monoacrylate, SR553 Methoxy Polyethylene Glycol (550) Monoacrylate, all available from Sartomer Americas, Exton, Pennsylvania; poly(ethylene glycol) methyl ether acrylate (Cat. No. 454990, Mₙ=480 g/mole) and poly(ethylene glycol) methyl ether acrylate (Cat. No. 730829, Mₙ=5000 g/mole), both available from Sigma-Aldrich; MPEG 550 Methoxy polyethylene glycol monoacrylate available from Kowa American Corp., New York, New York; Methoxypolyethylene acrylate MW 1000 and Methoxypolyethylene acrylate MW 2000, both from SimSon Pharma Limited, Mumbai, India; Poly(propylene glycol) methyl ether acrylate (Cat. No. 410187, Mₙ=260 g/mole), Poly(propylene glycol) methyl ether acrylate (Cat. No. 408352, Mₙ=375 g/mole), and Poly(propylene glycol) methyl ether acrylate (Cat. No. 454990, Mₙ=480 g/mole) all from Sigma-Aldrich. One useful monomer is an acrylic ester of Carbowax Methoxypolyethylene Glycol 750.

The amount of monomer unit b) may be, for example, 10 to 80 weight percent, 15 to 70 weight percent, 35 to 70 weight percent, 35 to 65 weight percent, or 35 to 45 weight percent, based on the total weight of the stabilizing copolymer. In some embodiments, the amount of monomer unit b) may be, for example, 55 to 80 weight percent or 70 to 80 weight percent, based on the total weight of the stabilizing copolymer.

In some embodiments, stabilizing copolymers according to the present disclosure further comprise from greater than 0 to 22 weight percent, 0.1 to 22 weight percent, 1 to 20 weight percent, 2 to 20 weight percent, 5 to 20 weight percent, or 5 to 15 weight percent, of at least one divalent acidic (meth)acrylic monomer unit, based on the total weight of the stabilizing copolymer. Examples of such divalent monomer units include

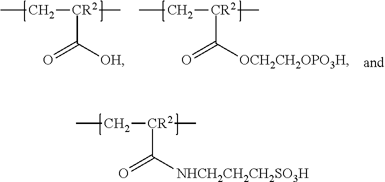

wherein R² is as previously defined. Exemplary commercially available monomers that can lead to divalent acidic (meth)acrylic monomer units include (meth)acrylic acid, beta-carboxyethyl acrylate, 2-sulfoethyl methacrylate, N-2-sulfoethyl methacrylamide, 2-hydroxyethyl (meth)acrylate phosphate, 2-phosphonethyl methacrylate. Many others can be envisioned and obtained commercially or prepared according to known methods.

Stabilizing copolymers according to the present disclosure can be made, for example, by free radical polymerization using well-known techniques. For example, the free-radically polymerizable monomers can be combined, typically in water and/or organic solvent, with a thermally activated free-radical initiator (e.g., a peroxide or azo compound) which is then heated under an inert atmosphere.

Alternatively, other techniques may be used such as, for example, ionizing radiation or ultraviolet radiation in combination with an included free-radical photoinitiator (e.g., benzophenone or α-cyclohexyl-α,α-dimethoxyacetophenone).

Examples of suitable thermal initiators include peroxides (e.g., benzoyl peroxide, dibenzoyl peroxide, dilauryl peroxide, cyclohexane peroxide, and methyl ethyl ketone peroxide), hydroperoxides (e.g., butyl hydroperoxide and cumene hydroperoxide), dicyclohexyl peroxydicarbonate, t-butyl perbenzoate, and azo compounds such as 2,2-azo-bis(isobutyronitrile) (AIBN), and combinations thereof. Examples of commercially available thermal initiators include initiators available under the “VAZO” trade designation from The Chemours Company (Wilmington, Delaware) such as VAZO 64 (2,2′-azobis(isobutyronitrile)), VAZO 52, VAZO 65 and VAZO 68 and initiators available under the “CELOGEN” trade designation from CelChem LLC, Naples, Florida. Peroxides are available from a variety of sources.

A free-radical polymerization initiator is used in an amount effective to cause free-radical polymerization of the free-radically polymerizable monomers. The amount will typically vary depending upon, for example, the type of initiator, the molecular weight of the initiator, the intended application of the resulting adhesive composition, and polymerization process factors such as temperature. The photoinitiator can be used in any amount effective to facilitate polymerization of the monomers (e.g., 0.1 part by weight to about 5 parts by weight, 0.2 part by weight to about 2 parts by weight, or about 0.1 part by weight to about 1 part by weight, per hundred parts by weight of the monofunctional monomers used to make the acrylic polymer).

If it is desired to control the molecular weight distribution of the stabilizing copolymer, a free-radical polymerization chain transfer agent may be added to the combined monomers before polymerization. Examples of useful chain transfer agents include but are not limited to those selected from the group consisting of carbon tetrabromide, alcohols, mercaptans, and mixtures thereof. Some preferred examples include thioglycerol, isooctyl mercaptoacetate, tert-dodecyl mercaptan, tert-nonyl mercaptan, n-octyl mercaptan, 1,8-dimercapto-3,6-dioxaoctane (DMDO), isooctyl 3-mercaptopropionate, and KF-2001 side-chain type/mercapto-modified reactive silicone from Shin-Etsu Chemical Co.

If present, the chain transfer agent(s) are typically present in an amount of up to about 1 part by weight of a chain transfer agent, typically about 0.01 to about 0.5 parts by weight, if used, preferably about 0.05 parts by weight to about 0.2 parts by weight, based upon 100 parts by weight of the combined monomers present.

### Adhesive Composition

Stabilizing copolymers according to the present disclosure are useful, for example, for stabilizing curable foams generated during the manufacture of certain acrylic adhesives, typically pressure-sensitive adhesives. Pressure-sensitive adhesives (PSAs) are known to those of ordinary skill in the art to possess properties including the following: (1) aggressive and permanent tack at room temperature, (2) adherence with no more than finger pressure, (3) sufficient ability to hold onto an adherend, and (4) sufficient cohesive strength to be cleanly removable from the adherend.

For example, an adhesive composition (e.g., a PSA) may comprise a polymeric material derived from a polymerizable adhesive precursor composition comprising at least one stabilizing copolymer according to the present disclosure, at least one alkyl (meth)acrylate having 7 to 24 carbon atoms, and at least one optional polar free-radically polymerizable monomer, and optionally a free-radically polymerizable crosslinker (e.g., a monomer having at least two free-radically polymerizable groups). In some embodiments, the adhesive compositions are foams, and in others they are not foams.

Typically, stabilizing copolymers according to the present disclosure, if included in polymerizable compositions used in the present disclosure, are often present in amounts of from 0.5 to 20, 1 to 15 weight percent, 1 to 10 weight percent, or even 1 to 5 weight percent, however this is not a requirement.

Useful acrylic acid esters can include acrylic or methacrylic acid esters of a monohydric alcohol having from 4 to 20, 4 to 18, 4 to 16, 4 to 12, 6 to 12, or 8 to 12 carbon atoms, which may be linear, branched, cyclic, or polycyclic. Examples of suitable monomers represented by Formula V include n-butyl acrylate, s-butyl acrylate, t-butyl acrylate, n-pentyl acrylate, isopentyl acrylate, hexyl acrylate, cyclohexyl acrylate, heptyl acrylate, isoamyl acrylate, 2-ethylhexyl acrylate, n-octyl acrylate, 2-octyl acrylate, isooctyl acrylate, n-nonyl acrylate, isononyl acrylate, n-decyl acrylate, isodecyl acrylate, n-dodecyl acrylate, isomyristyl acrylate, n-tridecyl acrylate, n-tetradecyl acrylate, lauryl acrylate, stearyl acrylate, isostearyl acrylate, isobornyl acrylate, 2-methylbutyl acrylate, 4-methyl-2-pentyl acrylate, octadecyl acrylate, 2-propylheptyl acrylate, methacrylates of the foregoing acrylates, and combinations thereof.

Further examples of useful acrylic acid esters can include mixtures of at least two or at least three structural isomers of a secondary alkyl (meth)acrylate represented by the formula

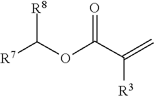

wherein R⁷ and R⁸ are each independently a C₁ to C₃₀ saturated linear alkyl group; the sum of the number of carbons in R⁷ and R⁸ is 7 to 31; and R¹ is as previously defined (i.e., hydrogen or methyl). The sum of the number of carbons in R⁷ and R⁸ can be, in some embodiments, 7 to 27, 7 to 25, 7 to 21, 7 to 17, 7 to 11, or 7. Methods for making and using such monomers and monomer mixtures are described in U.S. Pat. No. 9,102,774 (Clapper et al.).

Useful optional (but preferred) polar free-radically polymerizable monomers are more polar than the alkyl (meth)acrylate monomer(s). Examples of suitable optional polar free-radically polymerizable monomers useful for preparing acrylic PSAs include an acrylic acid (e.g., acrylic acid, methacrylic acid, itaconic acid, maleic acid, and fumaric acid), an acrylamide (e.g., acrylamide, methacrylamide, N-ethyl acrylamide, N-hydroxyethyl acrylamide, N-octyl acrylamide, N-t-butyl acrylamide, N,N-dimethyl acrylamide, N,N-diethyl acrylamide, N-ethyl-N-dihydroxyethyl acrylamide, and methacrylamides of the foregoing acrylamides), a hydroxyl- or amino-substituted acrylate (e.g., 2-hydroxyethyl acrylate, 3-hydroxypropyl acrylate, 2-hydroxybutyl acrylate, 4-hydroxybutyl acrylate, 6-hydroxyhexyl acrylate, 8-hydroxyoctyl acrylate, 10-hydroxydecyl acrylate, 12-hydroxylauryl acrylate, (4-hydroxymethylcyclohexyl)methyl acrylate, dimethylaminoethyl acrylate, t-butylaminoethyl acrylate, aminoethyl acrylate, N,N-dimethylaminoethyl acrylate, N,N-dimethylaminopropyl acrylate, and methacrylates of the foregoing acrylates), N-vinylpyrrolidone, N-vinylcaprolactam, a vinyl ether, a vinyl ester (vinyl acetate, vinyl benzoate, vinyl 4-tert-butylbenzoate, vinyl cinnamate, vinyl decanoate, vinyl neodecanoate, vinyl neononanoate, vinyl pivalate, vinyl propionate, vinyl stearate, and vinyl valerate), an allyl ether, a styrenic monomer (e.g., 4-tert-butoxystyrene, 4-(tert-butyl)styrene, 4-chloromethylstyrene, 3-chlorostyrene, 2-(diethylamino)ethylstyrene, 2-methylstyrene, 4-methylstyrene, 4-nitrostyrene, and 4-vinylbenzoic acid), a maleate, and combinations thereof.

In some embodiments, the optional polar free-radically polymerizable monomers acrylic polymer comprises at least one of acrylic acid, methacrylic acid, acrylamide, acrylonitrile, methacrylonitrile, an N-substituted acrylamide, an N,N-disubstituted acrylamide, a hydroxyalkyl acrylate, N-vinylcaprolactam, N-vinylpyrrolidone, maleic anhydride, or itaconic acid.

Other useful monomers that may be in acrylate-based adhesive compositions include ethylenically-unsaturated monomers such as methyl methacrylate, ethyl methacrylate, propyl methacrylate, and combinations thereof, for example.

Typically, the weight ratio of the at least one alkyl (meth)acrylate having 7 to 24 carbon atoms to the at least one optional polar free-radically polymerizable monomer is at least 50:50, at least 60:40, at least 70:30, at least 80:20, at least 85:15, at least 90:10, or at least 95:5, up to 99:1. Typically, the at least one alkyl (meth)acrylate having 7 to 24 carbon atoms to the at least one optional polar free-radically polymerizable monomer comprise at least 90 weight percent of the polymerizable adhesive precursor composition, preferably at least 95 percent.

While organic solvent and/or water may be included in the polymerizable adhesive precursor composition, preferably they are not present in an amount other than an adventitious amount due to impurity in one or more components.

Exemplary crosslinking agents include polyfunctional monomers having two or more free-radically polymerizable groups (e.g., di(meth)acrylates, tri(meth)acrylates, tetra(meth)acrylates). Suitable polyfunctional monomers include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, and dimethacrylates of any of the foregoing diacrylates. Further suitable polyfunctional monomers include polyacrylate esters of polyols, such as glycerol triacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof.

Crosslinking can also be achieved without a crosslinking agent by using high energy radiation such as gamma radiation or electron beam radiation.

The amount of crosslinker, if present, is typically an amount of 0.05 to 5 weight percent, 0.1 to 3 weight percent, or even 0.1 to 1.5 weight percent of the polymerizable adhesive precursor composition, however this is not a requirement.

In some embodiments, the free-radically polymerizable adhesive precursor composition further comprises at least one free-radical polymerization chain transfer agent.

In some embodiments, the free-radically polymerizable adhesive precursor composition comprises 0.5 to 20 weight percent of at least one stabilizing copolymer, and 80 to 99.5 weight percent of the free-radically polymerizable components combined, based on the combined total weight of the stabilizing copolymer and the free-radically polymerizable components.

The polymerizable adhesive precursor composition may be cured using thermal free-radical initiators as discussed above, but often is cured photochemically.

### Method

A useful solvent-free polymerization method is disclosed in U.S. Pat. No. 4,379,201 (Heilmann et al.). Initially, a mixture of first and second monomers can be polymerized with a portion of a free-radical photoinitiator by exposing the mixture to ultraviolet radiation in an inert environment for a time sufficient to form a coatable base syrup, and subsequently adding a crosslinking agent and the remainder of the photoinitiator. The crosslinking can be, for example, any of the polyfunctional crosslinking monomers described above in any of the amounts described above. This final syrup containing a crosslinking agent (e.g., which may have a Brookfield viscosity of about 500 centipoise (cps) to about 10000 cps at 23° C., about 100 cps to about 6000 cps at 23° C., or about 5,000 cps to about 7,500 cps at 23° C. as measured with a No. 4 LTV spindle, at 60 revolutions per minute) can then be coated onto a substrate. Once the syrup is coated onto the substrate, further polymerization and crosslinking can be carried out in an inert environment (e.g., nitrogen, carbon dioxide, helium, and argon, which exclude oxygen). A sufficiently inert atmosphere can be achieved by covering a layer of the photoactive syrup with a polymeric film, such as silicone-treated polyester film, that is transparent to ultraviolet radiation or e-beam irradiation.

Any suitable light source may be used, including fluorescent ultraviolet bulbs, mercury lamp (e.g., a low-pressure mercury lamp, a medium-pressure mercury lamp, a high-pressure mercury lamp, an ultrahigh-pressure mercury lamp), a xenon lamp, a metal halide lamp, an electrodeless lamp, an incandescent lamp, light emitting diodes (LEDs), and lasers. For broadband light sources (e.g., a fluorescent UV bulb, mercury lamp, or incandescent lamp), filters may be useful for narrowing the wavelength ranges to be within or outside the wavelength at which the ultraviolet light absorber absorbs and/or to modify the intensity of the light source.

The polymerizable adhesive precursor composition can also include other ingredients such as curing agents, cure accelerators, catalysts, tackifiers, plasticizers, dyes, flame retardants, adhesion promoters (e.g., coupling agents such as silane coupling agents), pigments, impact modifiers, flow control agents, foaming agents, fillers (e.g., talc, zinc oxide, and fused silica), glass and polymer microspheres and microparticles, electrically conductive particles, thermally conductive particles, fibers, antistatic agents, antioxidants such as hindered phenols, amines, and sulfur and phosphorous hydroperoxide decomposers, UV absorbers, stabilizers (e.g., hindered amine light stabilizers and heat stabilizers), and viscosity adjusting agents such as fumed silica.

Foamed adhesive compositions according to the present disclosure and/or made by the processes of the present disclosure can include hollow microspheres (e.g., hollow ceramic or glass microspheres or hollow polymeric microspheres such as elastomeric particles available, for example, from Akzo Nobel, Amsterdam, The Netherlands, under the trade designation EXPANCEL. Examples of hollow ceramic microspheres include alumina/silica microspheres having particle sizes in the range of 5 to 300 microns and a specific gravity of 0.7 (FILLITE, Pluess-Stauffer International, Oftringen, Switzerland), aluminum silicate microspheres having a specific gravity of from about 0.45 to about 0.7 (Z-LIGHT), calcium carbonate-coated polyvinylidene copolymer microspheres having a specific gravity of 0.13 (DUALITE 6001AE, Pierce & Stevens Chemical Corp., Cleveland, Ohio), and glass bubbles marketed by 3M Company, Saint Paul, Minnesota, as 3M GLASS BUBBLES in grades K1, K15, K₂O, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of 3M GLASS BUBBLES. Foams that include hollow microspheres are referred to as syntactic foams. Foamed adhesives can also include a hydrocarbon elastomer as described in U.S. Pat. No. 5,024,880 (Vesley et al.).

In some embodiments, the adhesive composition (and its precursor) comprises a tackifier, useful for increasing the stickiness of the surface of a PSA. In some embodiments, the foam composition does not comprise a tackifier. Useful tackifiers can have a number average molecular weight of up to 10,000 grams per mole, a softening point of at least 70° C. as determined using a ring and ball apparatus, and a glass transition temperature of at least −30° C. as measured by differential scanning calorimetry. Useful tackifiers are typically amorphous. In some embodiments, the tackifier is miscible with the polymer(s) of the PSA such that macroscopic phase separation does not occur in the PSA. In some embodiments, the PSA is free of microscopic phase separation as well. In some embodiments, the tackifier comprises at least one of rosin, a rosin ester, an ester of hydrogenated rosin, a polyterpene (e.g., those based on α-pinene, β-pinene, or limonene), a C₅/, C₉/, or C₅/C₉ hydrocarbon resin, an aliphatic hydrocarbon resin (e.g., those based on cis- or trans-piperylene, isoprene, 2-methyl-but-2-ene, cyclopentadiene, dicyclopentadiene, or combinations thereof), an aromatic resin (e.g., those based on styrene, α-methyl styrene, methyl indene, indene, coumarone, or combinations thereof), or a mixed aliphatic-aromatic hydrocarbon resin. Any of these tackifying resins may be hydrogenated (e.g., partially, or completely).

Examples suitable tackifiers include those obtained under the trade designations FLORAL including FORAL 85E (a glycerol ester of highly hydrogenated refined gum rosin) commercially available from Eastman Chemical Middleburg B.V., Middelburg, The Netherlands, FORAL 3085 (a glycerol ester of highly hydrogenated refined gum rosin) commercially available from Pinova, Brunswick, Georgia; ESCOREZ including ESCOREZ 2520 and ESCOREZ 5615 (aliphatic/aromatic hydrocarbon resins) commercially available from ExxonMobil Corp., Houston, Texas; ARKON such as ARKON P125 a fully hydrogenated hydrocarbon resin, commercially available from Arakawa Chemical Inc., Chicago, Illinois, and REGALITE such as REGALITE 7100 (a partially hydrogenated hydrocarbon resin) commercially available from Eastman, Kingsport, Tennessee.

In some embodiments, the adhesive composition (and its precursor) includes at least about one percent by weight and up to about 50 percent by weight of the tackifier, based on the total weight of the vehicle. In some embodiments, the tackifier is present in a range from 1 to 25, 2 to 20, 2 to 15, 1 to 10, or 3 to 10 percent by weight, based on the total weight of the vehicle.

Plasticizers may be added, e.g., to reduce vitrification of the adhesive composition. Suitable plasticizers include various polyalkylene oxides (e.g., polyethylene oxides or propylene oxides), adipic acid esters, formic acid esters, phosphoric acid esters, benzoic acid esters, phthalic acid esters, polyisobutylenes, polyolefins, and sulfonamides, naphthenic oils, plasticizing aids such as those materials described as plasticizers in the Dictionary of Rubber, K. F. Heinisch, 1974, pp. 359, John Wiley & Sons, New York, oils, elastomer oligomers, and waxes. The amount of plasticizer employed, if one is employed, will depend on the nature of the plasticizer and its compatibility with the vehicle.

In some embodiments, the adhesive composition of the present disclosure and/or made by the processes of the present disclosure is substantially solvent-free. Common organic solvents include aliphatic and alicyclic hydrocarbons (e.g., hexane, heptane, and cyclohexane), hydrocarbon solvents (e.g., benzene, toluene, xylenes, and d-limonene); acyclic and cyclic ketones (e.g., acetone, methyl ethyl ketone, and methyl isobutyl ketone, pentanone, hexanone, cyclopentanone, and cyclohexanone); ethers (e.g., diethyl ether, glyme, diglyme, diisopropyl ether, and tetrahydrofuran), esters (e.g., ethyl acetate and butyl acetate), sulfoxides (e.g., dimethyl sulfoxide), amides (e.g., N,N-dimethylformamide, N,N-dimethylacetamide, and N-methyl-2-pyrrolidone), halogenated solvents (e.g., methylchloroform, 1,1,2-trichloro-1,2,2-trifluoroethane, trichloroethylene, and trifluorotoluene), and alcoholic solvents (e.g., methanol, ethanol, or propanol such as isopropanol). The foam composition can be substantially free of any of these solvents.

The term “substantially free” means that the foam composition can include up to 0.5, 0.1, 0.05, or 0.01 percent by weight of any of these solvents or can be free of any of these solvents. These percentages are based on the total weight of the foam composition.

In some embodiments, the adhesive composition (and its precursor) includes a silane coupling agent. Examples of useful silane coupling agents include many of the silanes listed above useful for treating nanoparticles as well as epoxysilanes such as 2-(3,4-epoxycyclohexyl)ethyl trimethoxysilane, 3-glycidoxypropyl methyldimethoxysilane, 3-glycidoxypropyltrimethoxysilane, 3-glycidoxypropyl-methoxydimethoxysilane and 3-glycidoxypropyltriethoxysilane; and aminosilanes such as N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane and 3-aminopropyltriethoxysilane. The silane coupling agent can be used at a quantity of approximately 0.05 weight percent or higher or approximately 0.1 weight percent or higher and approximately 2 weight percent or lower or approximately 1 weight percent or lower relative to the total weight of the adhesive composition.

In some embodiments, the adhesive composition of the present disclosure and/or made by a process of the present disclosure further comprises a foaming agent. Useful foaming agents include physical foaming agents and chemical foaming agents, either of which may be inorganic foaming agents or organic foaming agents. Useful chemical foaming mechanisms include producing gas in situ through a chemical reaction; decomposition of a component of a composition, for example, a component that liberates gas upon thermal decomposition; evaporating a component of the composition, for example, a liquid gas; volatilizing a gas in the composition by decreasing the pressure on the composition or heating the composition; and combinations thereof.

Examples of chemical foaming agents include water and azo-, carbonate- and hydrazide-based molecules including, for example, 4,4′-oxybis(benzenesulfonyl)hydrazide, 4,4′-oxybenzenesulfonyl semicarbazide, azodicarbonamide, p-toluenesulfonyl semicarbazide, barium azodicarboxylate, azodiisobutyronitrile, benzenesulfonhydrazide, trihydrazinotriazine, metal salts of azodicarboxylic acids, oxalic acid hydrazide, hydrazocarboxylates, diphenyloxide-4,4′-disulphohydrazide, tetrazole compounds, sodium bicarbonate, ammonium bicarbonate, preparations of carbonate compounds and polycarbonic acids, and mixtures of citric acid and sodium bicarbonate, N,N′-dimethyl-N,N′-dinitroso-terephthalamide, N,N′-dinitrosopentamethylenetetramine, and combinations thereof. Water is a foaming agent useful for making a polyurethane foam. Water reacts with isocyanates to ultimately form carbon dioxide, which foams the polyurethane.

Suitable inorganic physical foaming agents include, for example, nitrogen, argon, oxygen, water, air, helium, sulfur hexafluoride, and combinations thereof.

Useful organic physical foaming agents include carbon dioxide, aliphatic hydrocarbons, aliphatic alcohols, fully and partially halogenated aliphatic hydrocarbons including, for example, methylene chloride, and combinations thereof. Examples of suitable aliphatic hydrocarbon foaming agents include members of the alkane series of hydrocarbons including, for example, methane, ethane, propane, n-butane, isobutane, n-pentane, isopentane and blends thereof. Useful aliphatic alcohols include, for example, methanol, ethanol, n-propanol, and isopropanol and combinations thereof. Suitable fully and partially halogenated aliphatic hydrocarbons include, for example, fluorocarbons, chlorocarbons, and chlorofluorocarbons and combinations thereof.

Examples of suitable halogenated (in some embodiments, fluorinated) foaming agents include methyl fluoride, perfluoromethane, ethyl fluoride, 1,1-difluoroethane (HFC-152a), fluoroethane (HFC-161), 1,1,1-trifluoroethane (HFC-143a), 1,1,1,2-tetrafluoroethane (HFC-134a), 1,1,2,2 tetrafluoroethane (HFC-134), 1,1,1,3,3-pentafluoropropane, pentafluoroethane (HFC-125), difluoromethane (HFC-32), perfluoroethane, 2,2-difluoropropane, 1,1,1-trifluoropropane, perfluoropropane, dichloropropane, difluoropropane, perfluorobutane, perfluorocyclobutane, methyl chloride, methylene chloride, ethyl chloride, 1,1,1-trichloroethane, 1,1-dichloro-1-fluoroethane (HCFC-141b), 1-chloro-1,1-difluoroethane (HCFC-142b), chlorodifluoromethane (HCFC-22), 1,1-dichloro-2,2,2-trifluoroethane (HCFC-123) and 1-chloro-1,2,2,2-tetrafluoroethane (HCFC-124), trichloromono-fluoromethane (CFC-11), dichlorodifluoromethane (CFC-12), trichloro-trifluoroethane (CFC-113), dichlorotetrafluoroethane (CFC-114), chloroheptafluoropropane, and dichlorohexafluoropropane and combinations thereof. In some embodiments, the foaming agent is not halogenated. In some embodiments, the foaming agent is not fluorinated.

The foaming agents may be used as single components, in mixtures and combinations thereof, as well as in mixtures with other co-foaming agents. A foaming agent can be added to a composition in an amount sufficient to achieve a desired foam density.

In some embodiments, the foam adhesive compositions of the present disclosure and/or made by a process of the present disclosure further comprises a nucleating agent. A nucleating agent can be any conventional nucleating agent. The amount of nucleating agent to be added may be selected depending upon the desired cell size, the selected foaming agent, and the density of the vehicle. Examples of inorganic nucleating agents in small particulate form include clay, talc, silica, and diatomaceous earth.

Organic nucleating agents can decompose or react at a given temperature. One example of an organic nucleating agent is a combination of an alkali metal salt of a polycarboxylic acid with a carbonate or bicarbonate. Examples of useful alkali metal salts of a polycarboxylic acid include the monosodium salt of 2,3-dihydroxybutanedioic acid (that is, sodium hydrogen tartrate), the monopotassium salt of butanedioic acid (that is, potassium hydrogen succinate), the trisodium and tripotassium salts of 2-hydroxy-1,2,3-propanetricarboxylic acid (that is, sodium and potassium citrate, respectively), and the disodium salt of ethanedioic acid (that is, sodium oxalate) and polycarboxylic acid such as 2-hydroxy-1,2,3-propanetricarboxylic acid, and combinations thereof. Examples of carbonates and bicarbonates include sodium carbonate, sodium bicarbonate, potassium bicarbonate, potassium carbonate, calcium carbonate, and combinations thereof. One contemplated combination is a monoalkali metal salt of a polycarboxylic acid, such as monosodium citrate or monosodium tartrate, with a carbonate or bicarbonate. It is contemplated that mixtures of different nucleating agents may be added to the vehicle. Other useful nucleating agents include a stoichiometric mixture of citric acid and sodium bicarbonate.

The adhesive composition precursor can be foamed by forming gas voids in the adhesive composition using a variety of mechanisms including mechanical mechanisms, chemical mechanisms, and combinations thereof. Useful mechanical foaming mechanisms include agitating (e.g., shaking, stirring, and/or whipping the composition), injecting gas into the composition, for example, inserting a nozzle beneath the surface of the composition and blowing gas into the composition, and combinations thereof. In some embodiments, introducing of the foaming agent comprises at least one of stirring the composition or injecting gas into the composition. In some embodiments, the foaming agent comprises at least one of air, nitrogen, oxygen, carbon dioxide, helium, argon, or nitrous oxide.

Curing of the adhesive precursor composition may be accomplished by heating (e.g., by including a thermal free-radical initiator as discussed above) and/or by exposure to actinic radiation (e.g., ultraviolet and/or visible light, gamma rays, or an electron beam), and/or chemical agents. Of these exposure to actinic radiation is typically preferred due to ease of implementation. In those embodiments wherein the polymer matrix contains free-radically polymerizable ethylenic unsaturation, the adhesive layer preferably further comprises a photoinitiator (i.e., for free-radical polymerization). If present, the amount of photoinitiator is typically an effective amount that is at least sufficient amount to cause at least partial curing of the adhesive layer upon exposure to sufficient actinic radiation. Typically, effective amounts of photoinitiator comprise less than 5 percent by weight, more typically less than 3 percent by weight, and more typically less than 1 percent by weight of the total adhesive layer. It will be recognized that curing may be complete even though polymerizable (meth)acrylate groups remain.

Exemplary photoinitiators include α-cleavage photoinitiators such as benzoin and its derivatives such as α-methylbenzoin; α-phenylbenzoin; α-allylbenzoin; α-benzylbenzoin; benzoin ethers such as benzil dimethyl ketal (available as IRGACURE 651 from Ciba Specialty Chemicals, Tarrytown, New York), benzoin methyl ether, benzoin ethyl ether, benzoin n-butyl ether; acetophenone and its derivatives such as 2-hydroxy-2-methyl-1-phenyl-1-propanone (available as DAROCUR 1173 from Ciba Specialty Chemicals) and 1-hydroxycyclohexyl phenyl ketone (available as IRGACURE 184 from Ciba Specialty Chemicals); 2-methyl-1-[4-(methylthio)phenyl]-2-(4-morpholinyl)-1-propanone (available as IRGACURE 907 from Ciba Specialty Chemicals); 2-benzyl-2-(dimethylamino)-1-[4-(4-morpholinyl)-phenyl]-1-butanone (available as IRGACURE 369 from Ciba Specialty Chemicals); titanium complexes such as bis(η₅-2,4-cyclopentadien-1-yl)bis[2,6-difluoro-3-(1H-pyrrol-1-yl)phenyl]titanium (available as CGI 784 DC from Ciba Specialty Chemicals); and mono- and bis-acylphosphines (available from Ciba Specialty Chemicals as IRGACURE 1700, IRGACURE 1800, IRGACURE 1850, and DAROCUR 4265). One useful photoinitiator, a difunctional alpha hydroxyketone, is available as ESACURE ONE from Lamberti S.p.A, Albizzate, Italy.

Preferably, if an acylphosphine or acylphosphine oxide photoinitiator is utilized, it is combined with a photoinitiator (e.g., 2-hydroxy-2-methyl-1-phenyl-1-propanone) having a high extinction coefficient at one or more wavelengths of the actinic radiation. Such combination typically facilitates surface cure while maintaining low levels of costly photoinitiator.

Other useful photoinitiators include: anthraquinones (e.g., anthraquinone, 2-ethylanthraquinone, 1-chloroanthraquinone, 1,4-dimethylanthmquinone, 1-methoxyanthraquinone) and benzophenone and its derivatives (e.g., phenoxybenzophenone, phenylbenzophenone).

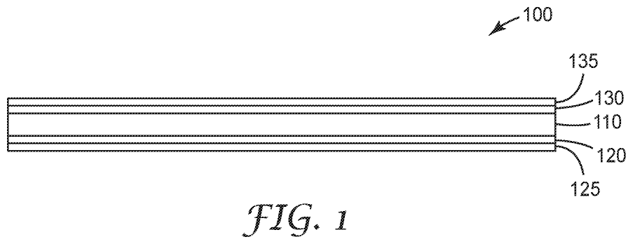

The adhesive composition can be included in a tape such as a pressure-sensitive adhesive tape. Useful adhesive tape constructions include, for example, one or more adhesive compositions disposed on a substrate, for example, a core layer (e.g., see FIG. 1 described hereinbelow) or a release liner, and, optionally, wound in the form of a roll. In some embodiments, the foam tape construction includes an adhesive composition disposed on a surface of a foam core, which forms a tape having an adhesive layer on one side of the foam tape, that is, a single coated adhesive tape. In another embodiment, the foam composition can be in the form of a tape having an adhesive layer on two major surfaces of a foam core, which is known as double-coated foam tape.

The present disclosure provides a process for making an adhesive tape, the process comprising applying the foam composition to a substrate. Applying the adhesive composition to a substrate can be carried out after it is foamed using any of the methods described above, that is, after voids are formed therein. The foamed adhesive composition can be applied to the substrate using a variety of methods (e.g., dipping, spraying, brushing, roll coating, bar coating). In some embodiments, the composition can be coated on a liner with a notch bar with a gap setting to provide the desired thickness above the liner, and another liner may be added to maintain a gap of the desired thickness. Although any of the foamed adhesive compositions described above in any of their embodiments can be applied to a substrate, in some embodiments, the vehicle comprises a monomer and optionally a polymer, and the process further comprises polymerizing the monomer. In some embodiments, the process further comprises crosslinking the foam composition. When polymerizing or crosslinking using an ultraviolet light (UV) source such as any of those described above is used, any useful amount of UV irradiation can be employed, such as from approximately 1000 mJ/cm² to approximately 10000 mJ/cm², from approximately 1000 mJ/cm² to approximately 5000 mJ/cm², or from approximately 1000 mJ/cm² to approximately 3000 mJ/cm².

Adhesive articles have a variety of useful applications including, for example, bonding two substrates together, mounting applications using articles including hooks, hangers, and holders, joining applications including adhering two or more containers, for example, boxes, together for later separation, bonding articles to surfaces such as, for example, walls, floors, ceilings, and counters and replacing mechanical fasteners, mastics, or liquid glues. When bonding rough or irregular surfaces, the properties and formulation of the foam tape may be selected to provide a foam tape that distributes stress uniformly over the bonded area. Other adhesive foam applications include, for example, as structural adhesives and foam-in-place adhesives.

The adhesive composition can also be subjected to post processes including, for example, die cutting, crosslinking, and sterilization.

### Article

Adhesive compositions according to the present disclosure can be used to manufacture articles. Referring now to FIG. 1, exemplary adhesive article 100 comprises a substrate (shown as a foam core layer) 110 sandwiched between first adhesive layer 120 and optional second adhesive layer 130. Optional release liners 125, 135 are releasably adhered to first and second adhesive layers 120, 130, respectively.

While illustrated as a foam core layer, virtually any adherable substrate can be used. Examples of suitable substrates include thermoplastic polymer films (e.g., polyester), metal (including also painted metal), glass, wood, dry wall, and ceramic.

In some embodiments (not shown), such as a roll of double-sided adhesive tape a single double-sided release liner may be used instead of dual release liners.

Exemplary articles according to the present disclosure include various adhesive tapes such as transfer tapes, single-sided adhesive tapes, dual-sided adhesive tapes, or die-cut adhesive articles, which may be included in an electronic device such as a cell phone, laptop computer, tablet computer, radio, and/or television.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted or readily apparent from the context, all parts, percentages, ratios, etc. in the Examples and the rest of the specification are by weight. Table 1, below, describes material used in the Examples.

TABLE 1

| ABBREVIATION | DESCRIPTION AND SOURCE |
|---|---|
| TRIS-M | 3-(methacryloyloxy)propyltris(trimethylsiloxy)silane, obtained from |
| | Entegris, Ambler, Pennsylvania |
| AA | Acrylic acid, obtained from The Dow Chemical Company, Midland, |
| | Michigan |
| VAZO 67 | 2,2′-azobis(2-methylbutanenitrile), obtained as VAZO 67 from The |
| | Chemours Company, Wilmington, Delaware |
| 750 g/mol | Carbowax methoxypolyethylene glycol 750, available from Dow |
| carbowax alcohol | Chemical, Midland, Michigan, molecular weight 750 grams/mole (g/mol) |
| 750A | Acrylic ester of 750 g/mol carbowax alcohol made according to the |
| | procedure described hereinafter |
| 750MA | Methacrylic ester of 750 g/mol carbowax alcohol made according to the |
| | procedure describer hereinafter |
| L44 | L44 was obtained as PLURONIC L44 from BASF Corp., Florham Park, |
| | New Jersey. It is an ethylene oxide (EO)/propylene oxide (PPO) block |
| | copolymer having the nominal formula: EO₉-PPO₂₁-EO₉ |
| L44A | Acrylic monoester of Pluronic L44, made according to the procedure |
| | mentioned hereinafter |
| S10 | Polyethylene glycol octadecyl ether, obtained under the trade designation |
| | BRIJ S10 from Sigma Aldrich, St. Louis, Missouri |
| S10A | Acrylic monoester of BRIJ S10, made according to the procedure |
| | mentioned hereinafter |
| TG | Thioglycerol, obtained from Millipore Sigma, St. Louis, Missouri |
| M11 | Monomethacryloxypropyl terminated polydimethylsiloxane, asymmetric, |
| | 10 cSt viscosity, obtained as MCR-M11 from Gelest, Morrisville, |
| | Pennsylvania |
| 2404 | Single-end type, methacryl-modified, reactive silicone fluid having a |
| | functional group equivalent weight of 420 g/mol, obtained as product |
| | grade X-22-2404 from Shin-Etsu Chemical Co., Tokyo, Japan |
| 174ASX | Single-end type, methacryl-modified, reactive silicone fluid having a |
| | functional group equivalent weight of 900 g/mol, obtained under the |
| | product grade X-22-174ASX from Shin-Etsu Chemical Co., Tokyo, |
| | Japan |
| 174BX | Single-end type, methacryl-modified, reactive silicone fluid having a |
| | functional group equivalent weight of 2300 g/mol, obtained under the |
| | product grade X-22-174BX from Shin-Etsu Chemical Co., Tokyo, Japan |
| 2012 | Single-end type, methacryl-modified, reactive silicone fluid having a |
| | functional group equivalent weight of 4600 g/mol, obtained under the |
| | product grade KF-2012 from Shin-Etsu Chemical Co., Tokyo, Japan |
| 2-EHA | 2-Ethylhexyl acrylate, obtained from BASF, Ludwigshafen, Germany |
| IOA | Isooctyl acrylate, obtained from 3M Company, Cordova, Iowa, United |
| | States |
| ISA | Isostearyl acrylate, obtained as product name NK Ester S1800A from |
| | Kowa Shin Nakamura, Tokyo, Japan |
| SR9050 | Believed to be a mixture of hydroxyethyl methacrylate phosphoric acid |
| | ester and 2-(2-ethoxyethoxy)ethyl methacrylate, obtained under the |
| | product number SR9050 from Sartomer Americas, Exton, Pennsylvania |
| K15 Glass Bubbles | 3M Glass Bubbles, density = 0.15 g/cm³, 60 microns mean particle |
| | diameter from 3M Company |

### Preparation of 750A

A 500 mL 3-necked round-bottomed flask equipped with a Dean-Stark trap and water condenser was charged with Carbowax 750 alcohol (112.4 g), toluene (119.6 g), phenothiazine (58.3 mg), acrylic acid (13.3 g) and para-toluenesulfonic acid (4.6 g, PTSA). The mixture was heated to reflux for twenty hours and the water formed was collected in the Dean-Stark trap. The mixture was then allowed to cool to 60° C. Calcium hydroxide (3.5 g) was added to neutralize the PTSA and excess acrylic acid. The mixture was kept at 60° C. for 30 minutes, then allowed to cool down to 25° C. with stirring for 6 hours. The solution was filtered and then concentrated under reduced vacuum (20 Torr) and heat (93° C.) to produce 118.1 g of an amber liquid which solidified to a tan solid when cooled to room temperature. This was dissolved in 78.7 g of ethyl acetate to make a 60% solids dark amber solution

### Preparation of 750MA

A 500 mL 3-necked RB flask equipped with a Dean-Stark trap and water condenser was charged with Carbowax 750 alcohol (112.4 g), toluene (119.6 g), phenothiazine (58.3 mg), methacrylic acid (15.8 g) and para-toluenesulfonic acid (PTSA, 4.6 g). The mixture was heated to rnflux for twenty hours and the water formed was collected in the Dean-Stark trap. The mixture was then allowed to cool to 60° C. Calcium hydroxide (3.5 g) was added to neutralize the PTSA and excess methacrylic acid. The mixture was kept at 60° C. for 30 minutes, then allowed to cool down to 25° C. with stirring for 6 hours. The solution was filtered and then concentrated under reduced vacuum (20 Torr) and heat (93° C.) to produce 120.7 g of an amber liquid which solidified to a tan solid when cooled to room temperature.

### Preparation of L44-Acrylate:

A 500 mL 3-necked round-bottomed flask equipped with a Dean-Stark trap and water condenser was charged with Pluronic L44 alcohol (163.7 g), toluene (100.6 g), phenothiazine (49.4 mg), acrylic acid (7.3 g) and methanesulfonic acid (2.0 g, MSA). The mixture was heated to reflux for twenty hours and the water formed was collected in the Dean-Stark trap. The mixture was then allowed to cool to 60° C. Calcium hydroxide (2.9 g) was added to neutralize the MSA and excess acrylic acid. The mixture was kept at 60° C. for 30 minutes, then allowed to cool down to 25° C. with stirring for 6 hours. The solution was filtered to produce an amber solution (255.0 g).

### Preparation of S10A

A 500 mL 3-necked RB flask equipped with a Dean-Stark trap and water condenser was charged with Brij S-10 (100 g), toluene (112.2 g), phenothiazine (54.7 mg), acrylic acid (12.4 g) and para-toluene sulfonic acid (4.3 g). The mixture was heated to reflux for twenty hours and the water formed was collected in the Dean-Stark trap. The mixture was then allowed to cool to 60° C. Calcium Hydroxide (3.3 g) was added to neutralize the PTSA and excess methacrylic acid. The mixture was kept at 60 C for 30 minutes, then allowed to cool down to 25° C. with stirring for 6 hours. The solution was filtered and then concentrated under reduced vacuum (20 Torr) and heat (93° C.) to produce 105.0 g of a dark amber liquid which solidified to a tan solid when cooled to room temperature.

### Examples EX-1 to EX-17, Comparative Examples CE-A and CE-B, and Preparative Examples PEX-1 to PEX-6

### Copolymer Preparation:

To a vial containing a magnetic stir bar were added the reagents reported in Tables 2 to 7 for the indicated composition, values in parts by weight. To ethyl acetate was added VAZO 67 to yield a 0.33 wt. % solution of VAZO 67 in ethyl acetate. To the vial was then added the ethyl acetate/VAZO 67 solution, wherein the weight of solution was equivalent to the total weight of reagents. The solution was then sparged with nitrogen, the was vial sealed, and the mixture was set to stir in a 60° C. water bath for 24 hours. The appearance of the solutions is indicated in the given table under “Clear Solution (Y/N)” after 24 hours by visual inspection, where “Y” equals “Yes” and “N” equals “No”.

### Preparation of Foaming Monomer Solutions Including Stabilizing Copolymers

In a 4-ounce glass jar containing a magnetic stir bar was placed 30.0 g of an acrylic monomer composition (90% 2-EHA, 10% AA). To the glass jar was then added 0.3 g of the indicated stabilizing copolymer and the jar was sealed. The solution was stirred for five minutes and then rested for five minutes before foaming was observed by visual inspection. Results are reported in Tables 2 to 7. The results are listed under “Stable Foam (Y/N)” for each stabilizing copolymer, where “Y” equals “Yes” and “N” equals “No”.

TABLE 2

| | | | | | CLEAR | STABLE |
|---|---|---|---|---|---|---|
| | PARTS BY WEIGHT | | | | SOLUTION | FOAM |
| EXAMPLE | TRIS-M | 750A | AA | TG | (Y/N) | (Y/N) |
| Preparative | 25 | 70 | 5 | 1.0 | Y | N |
| Example | | | | | | |
| PEX-1 | | | | | | |
| Preparative | 25 | 70 | 5 | — | Y | Y |
| Example | | | | | | |
| PEX-2 | | | | | | |
| Preparative | 60 | 40 | — | — | Y | Y |
| Example | | | | | | |
| PEX-3 | | | | | | |
| Preparative | 90 | 10 | — | — | Y | Y |
| Example | | | | | | |
| PEX-4 | | | | | | |

TABLE 3

| | | | | | | | | | | CLEAR | STABLE |
|---|---|---|---|---|---|---|---|---|---|---|---|
| | PARTS BY WEIGHT | | | | | | | | | SOLUTION | FOAM |
| EXAMPLE | 2404 | 174ASX | 174BX | M11 | 2012 | 750A | L44A | AA | TG | (Y/N) | (Y/N) |
| EX-1 | 60 | — | — | — | — | 35 | — | 5 | 1.0 | Y | N |
| EX-2 | 45 | — | — | — | — | 40 | — | 15 | 2.0 | N | Y |
| EX-3 | — | 45 | — | — | — | 40 | — | 15 | 2.0 | N | Y |
| EX-4 | — | — | 45 | — | — | 40 | — | 15 | 2.0 | N | N |
| EX-5 | — | — | — | — | 45 | 40 | — | 15 | 2.0 | N | N |
| EX-6 | — | — | 45 | — | — | — | 40 | 15 | 2.0 | Y | Y |
| EX-7 | 20 | — | — | — | — | — | 65 | 15 | 2.0 | Y | Y |
| EX-8 | — | 20 | — | — | — | — | 65 | 15 | 2.0 | Y | Y |
| EX-9 | — | — | 20 | — | — | — | 65 | 15 | 2.0 | Y | Y |
| EX-10 | — | — | — | 60 | — | 35 | — | 5 | 1.0 | Y | N |
| EX-11 | — | — | — | — | 52 | 35 | — | 13 | 1.0 | N | Y |
| EX-12 | — | — | — | — | 58 | 20 | — | 22 | 0.57 | N | Y |
| EX-13 | — | — | — | — | 60 | 35 | — | 5 | 1.0 | N | Y |
| EX-14 | — | — | — | — | 64 | 35 | — | 1 | 1.0 | Y | Y |
| EX-15 | — | — | — | — | 75 | 20 | — | 5 | 0.57 | N | Y |
| EX-16 | — | — | — | — | 78 | 20 | — | 2 | 0.57 | N | Y |
| EX-17 | — | — | — | — | 79 | 17 | — | 4 | — | N | Y |

TABLE 4

| | | | | | CLEAR | STABLE |
|---|---|---|---|---|---|---|
| | PARTS BY WEIGHT | | | | SOLUTION | FOAM |
| EXAMPLE | TRIS-M | 2012 | L44A | AA | (Y/N) | (Y/N) |
| PEX-5 | 40 | 40 | 16 | 4 | Y | Y |

TABLE 5

| | | | | | CLEAR | STABLE |
|---|---|---|---|---|---|---|
| | PARTS BY WEIGHT | | | | SOLUTION | FOAM |
| EXAMPLE | TRIS-M | 750A | SR9050 | TG | (Y/N) | (Y/N) |
| PEX-6 | 60 | 38 | 2 | 0.10 | Y | Y |

TABLE 6

| | | | | CLEAR | STABLE |
|---|---|---|---|---|---|
| | PARTS BY WEIGHT | | | SOLUTION | FOAM |
| EXAMPLE | TRIS-M | S10A | TG | (Y/N) | (Y/N) |
| PEX-7 | 67 | 33 | 0.10 | Y | Y |

TABLE 7

| | | | | CLEAR | STABLE |
|---|---|---|---|---|---|
| | PARTS BY WEIGHT | | | SOLUTION | FOAM |
| EXAMPLE | TRIS-M | 750MA | TG | (Y/N) | (Y/N) |
| PEX-8 | 67 | 33 | 0.10 | Y | Y |

### Examples 40-49

Coatable viscosity syrup polymers were prepared by mixing 92 parts of 2-EHA, 8 parts of AA, and OMNIRAD 651 photoinitiator (0.04 parts per hundred parts of monomers) until a homogeneous mixture was obtained. The mixture was purged with nitrogen while stirring for at least 5 minutes. While stirring, the mixture was exposed to a UV-A light source having a peak emission wavelength of 365 nm) until a syrup having a viscosity deemed suitable for coating was formed. Following UV-A light exposure, air was introduced. An additional 0.10 part per hundred of OMNIRAD 651 photoinitiator and 0.06 part per hundred of 1,6-hexanediol diacrylate were added to the syrup and mixed until a homogeneous mixture was obtained. This mixture was transferred to a high shear mixer, where 2 parts per hundred of A200 hydrophilic fumed silica was added and mixed until dispersed. This mixture was transferred to a low shear mixer, where 5 parts per hundred of K15 glass bubbles were added and mixed until dispersed.

The mixture was then placed under vacuum for 8 minutes to remove excess air introduced during mixing, then pumped through tubing where various surfactants were introduced in-line at various concentrations (as reported in Table 8). Nitrogen gas was introduced in-line through a sintered metal frit into the syrup/surfactant mixture. This mixture was then pumped through a rotor stator mixer spinning at greater than 100 revolutions per minutes (rpm) and pumped on to a silicone-coated polyester liner web. A rolling bank of foamed syrup was established at the inlet of a nip set to a specific caliper. After passing through the nip, a secondary polyester liner was added to the top side of the foamed syrup and was passed through a light source for various times and intensities until the foamed syrup was converted to >97% polymer PSA. The light source had a peak emission wavelength of about 365 nm, and imparted a dosage of about 1.7 J/cm².

The final foamed PSA produced was measured for caliper and density and rated for visual appearance (as reported in Table 8), where a rating of 1 equates to poor appearance with the presence many large pinholes and a rating of 5 equates to excellent appearance with no pinholes present.

TABLE 8

| | | | SURFACTANT | PSA FOAM | PSA FOAM | PSA FOAM |
|---|---|---|---|---|---|---|
| | | SURFACTANT | CONCENTRATION, | CALIPER, | DENSITY, | VISUAL |
| | SURFACTANT | COMPOSITION | percent by | mils | lbs/ft³ | RATING |
| EXAMPLE | SAMPLE | (SOLVENT SYSTEM) | weight | (microns) | (kg/liter) | (1-5) |
| 18 | — | 15/40/45 AA/L44/174BX | 3.0 | 32.5 | 42.2 | 4 |
| | | (50% ethyl acetate) | | (826) | (0.676) | |
| 19 | EX-3 | 15/40/45 AA/750A/174ASX | 3.0 | 32.0 | 40.7 | 2 |
| | | (50% ethyl acetate) | | (813) | (0.652) | |
| 20 | — | 15/65/20 AA/Pluronic | 3.0 | 32.3 | 41.3 | 2 |
| | | L44/174BX | | (820) | (0.662) | |
| | | (50% ethyl acetate) | | | | |
| 21 | — | 50/40/10 TRIS-M/750A/2-EHA | 3.0 | 32.3 | 42.3 | 3 |
| | | (50% ethyl acetate) | | (820) | (678) | |
| 22 | — | 50/40/10 TRIS-M/750A/2-EHA | 4.5 | 32.0 | 42.4 | 3 |
| | | (50% ethyl acetate) | | (813) | (679) | |
| 23 | PEX-2 | 90/10 TRIS-M/750A | 3.0 | 32.4 | 40.2 | 4 |
| | | (50% ethyl acetate) | | (823) | (0.644) | |
| 24 | PEX-2 | 90/10 TRIS-M/750A | 1.9 | 32.5 | 42.1 | 4 |
| | | (50% ethyl acetate) | | (826) | (0.674) | |
| 25 | — | 85/5/10 TRIS-M/AA/750A | 3.0 | 31.8 | 43.4 | 2 |
| | | (50% ethyl acetate) | | (808) | (0.695) | |
| 26 | PEX-1 | 60/40 TRIS-M/750A | 3.0 | 32.0 | 41.3 | 4 |
| | | (50% ethyl acetate) | | (813) | (0.662) | |
| 27 | — | 60/40 TRIS-M/750A | 3.0 | 32.3 | 41.3 | 3 |
| | | (50% 2-EHA) | | (820) | (0.662) | |

The preceding description, given in order to enable one of ordinary skill in the art to practice the claimed disclosure, is not to be construed as limiting the scope of the disclosure, which is defined by the claims and all equivalents thereto.

1. An adhesive composition comprising a polymerized composition comprising components:
i) at least one stabilizing copolymer comprising:
a) 20 to 90 weight percent of at least one first divalent monomer unit represented by: or
wherein:
each R¹ is independently H or methyl;
each R² is independently methyl or ethyl;
each R³ is independently methylene, ethylene, or propylene;
each R⁴ is independently methyl, ethyl, propyl, or butyl;
each n is independently an integer from 2 to 65; and
b) 10 to 80 weight percent of at least one second divalent monomer unit represented by
wherein:
each R⁶ independently represents a poly(alkyleneoxy) group, wherein the poly(alkyleneoxy) group comprises ethyleneoxy groups; and
each X independently represents H or alkyl having 1 to 6 carbon atoms; and
at least one first crosslinking agent;
ii) at least one alkyl (meth)acrylate having 7 to 24 carbon atoms;
iii) at least one optional polar free-radically polymerizable monomer; and
iv) at least one second crosslinking agent.

2. The adhesive composition of claim 1, wherein the at least one optional polar free-radically polymerizable monomer is present.

3. The adhesive composition of claim 1, wherein the adhesive composition comprises
0.5 to 20 weight percent of component i); and
80 to 99.5 weight percent of components ii), iii), and iv) combined, based on the combined total weight of components i), ii), iii) and iv).

4. The adhesive composition of claim 2, wherein components ii) and iii) are present in amounts of 50 to 99 weight percent and 1 to 50 weight percent, respectively, based on the total weight of components ii) and iii) combined.

5. The adhesive composition of claim 1, wherein the adhesive composition is a pressure-sensitive adhesive.

6. An article comprising:
a substrate; and
the adhesive composition of claim 1 adhered to the substrate.

7. The article of claim 6, wherein the article comprises a transfer tape, a one-sided adhesive tape, a dual-sided adhesive tape, or a die-cut adhesive.

8. The article of claim 7, wherein at least one of the substrate or the adhesive composition comprises a foam.

9. A method of making an adhesive composition, the method comprising the sequential steps:
I) providing a first polymerizable composition comprising:
at least one alkyl (meth)acrylate;
at least one optional first polar free-radically polymerizable monomer; and
at least one first free-radical polymerization initiator;
II) forming a syrup composition by partially polymerizing the first polymerizable composition, wherein the syrup composition comprises:
1 to 20 weight percent of a solute polymer based on the total weight of the syrup composition, the solute polymer having a weight average molecular weight of at least 100000 daltons; and
80 to 99 weight percent of solvent monomers based on the total weight of the syrup composition, the solvent monomers comprising:
the at least one alkyl (meth)acrylate; and
the at least one optional first polar free-radically polymerizable monomer; and
III) preparing a second polymerizable composition comprising:
the syrup composition;
at least one optional second polar free-radically polymerizable monomer, wherein the at least one optional second polar free-radically polymerizable monomer and the at least one optional first polar free-radically polymerizable monomer may be the same or different;
at least one stabilizing copolymer comprising:
a) 20 to 90 weight percent of at least one first divalent monomer unit represented by: or
wherein:
each R¹ is independently H or methyl;
each R² is independently methyl or ethyl;
each R³ is independently methylene, ethylene, or propylene;
each R⁴ is independently methyl, ethyl, propyl, or butyl;
each n is independently an integer from 2 to 65; and
b) 10 to 80 weight percent of at least one second divalent monomer unit represented by
wherein:
each R6 independently represents a poly(alkyleneoxy) group, wherein the poly(alkyleneoxy) group comprises ethyleneoxy groups; and
each X independently represents H or alkyl having 1 to 6 carbon atoms;
at least one crosslinking agent;
at least one second free-radical initiator;
IV) frothing the second polymerizable composition to provide a frothed polymerizable composition; and
V) polymerizing the frothed polymerizable composition to form the adhesive composition.

10. The method of claim 9, wherein the second polymerizable composition further comprises a free-radical polymerization chain transfer agent.

11. The method of claim 9, wherein at least one of the at least one first or second free-radical initiator comprises a free-radical photoinitiator.

12. The method of claim 9, wherein step V) comprises exposing the second polymerizable composition to actinic electromagnetic radiation.

13. A stabilizing copolymer comprising:
a) 20 to 90 weight percent of at least one first divalent monomer unit represented by:
wherein:
each R¹ is independently H or methyl;
each R³ is independently methylene, ethylene, or propylene;
each R⁴ is independently methyl, ethyl, propyl, or butyl;
each n is independently an integer from 2 to 65; and
b) 10 to 80 weight percent of at least one second divalent monomer unit represented by
wherein:
each R⁶ independently represents a poly(alkyleneoxy) group, wherein the poly(alkyleneoxy) group comprises ethyleneoxy groups; and
each X independently represents H or alkyl having 1 to 6 carbon atoms.

14. The stabilizing copolymer of claim 13, wherein the poly(alkyleneoxy) group further comprises isopropyleneoxy groups.

15. The stabilizing copolymer of claim 13, further comprising:
c) from greater than 0 to 22 weight percent of at least one divalent acidic (meth)acrylic monomer unit.
